(19) United States
(12) Patent Application Publication
(10) Pub. No.: US 2006/0013009 A1
(43) Pub. Date: Jan. 19, 2006

(54) Recessed to spot light converter

(76) Inventor: Stephen F. Falco JR., Oakhurst, NJ (US)

Correspondence Address: Stephen F. Falco, Jr., 190 Whalepond Road, Oakhurst, NJ, 07755-1352, US

(21) Appl. No.: 10/893,845

(22) Filed: Jul. 19, 2004

(51) Int. Cl. F21S 8/08

(52) U.S. Cl. 362/418

(57) ABSTRACT

A recessed to spot light converter has an Edison base electrical connector mounted on an adjustable length shaft. The shaft is connected to a rotatably mounted two-arm frame, which pivotally mounts a spot light between the arms. The arms also mount a cover plate. In operation, the bulb of a recessed light is removed and replaced with the Edison connector. The shaft is then adjusted and the cover plate positioned over the recessed light opening to give the installation a finished appearance.

### CROSS REFERENCE TO RELATED APPLICATIONS

None.

### BACKGROUND OF THE INVENTION

1. Field of the Invention

The present invention is a recessed to spot light converter having a screw in adapter, which replaces the recessed light bulb with a spot light fixture.

2. Description of the Related Art

Schwartz, U.S. Pat. No. 2,309,991, FIG. 2, shows a plug socket connected to a universal swivel structure, then to a lamp socket. This enables the lamb to swivel about its vertical axis.

Krause, U.S. Pat. No. 4,835,748, is representative of a number of patents showing structures for converting a single bulb socket to multiple bulb sockets.

Hefner. U.S. Pat. No. 5,186,469, has a central socket and three sockets radiating from the central socket.

Scales, U.S. Pat. No. 6,523,970, shows an outdoor spot light, which mounts in a first socket and has two spotlights extending from the first socket. One of the spotlights is flexibly mounted on the extension.

### SUMMARY OF THE INVENTION

Recessed and spot lighting fixtures are widely used. Spotlights generally require track type supporting structures. The present invention easily converts a recessed light into a spot light without the need for any structural changes in the recessed lighting fixture.

The bulb is removed from the recessed light and the converter of the invention is inserted therein. The converter includes a threaded male electrical connector of the Edison base type for engaging the female electrical light fixture Edison base portion after the bulb is removed. The male electrical socket portion is connected to a variable length shaft. The other end of the shaft is connected to a swivel mounting which can rotate 360° in both directions. The swivel is connected to a supporting frame for pivotally mounting a spot light thereon. A cover plate is also connected to the frame at a point between the spot light and the swivel.

In operation, the invention converts a recessed light into a spot light. A “finished” appearance is achieved by providing for an adjustable length mounting of the spot light so that the cover plate can completely cover the recessed light fixture.

A principal object of the invention is to provide a lighting fixture, which converts a recessed light into a spotlight.

A further object of the invention is the provision of spotlight, which is easily connected, in a recessed lighting fixture in place of the bulb.

Another object of the invention is the provision of spot light conversion device, which is adjustable in length, rotatable about a vertical axis and pivotable with respect to a supporting frame.

The foregoing, as well as further objects and advantages of the invention will become apparent to those skilled in the art from a review of the following detailed description of my invention, reference being made to the accompanying drawings.

### BRIEF DESCRIPTION OF THE DRAWINGS

FIG. 1 is a perspective view of the preferred embodiment of my invention; and

FIG. 2 is a side view of the structure of FIG. 1, connected to a recessed lighting fixture.

### DETAILED DESCRIPTION OF THE PREFERRED EMBODIMENT

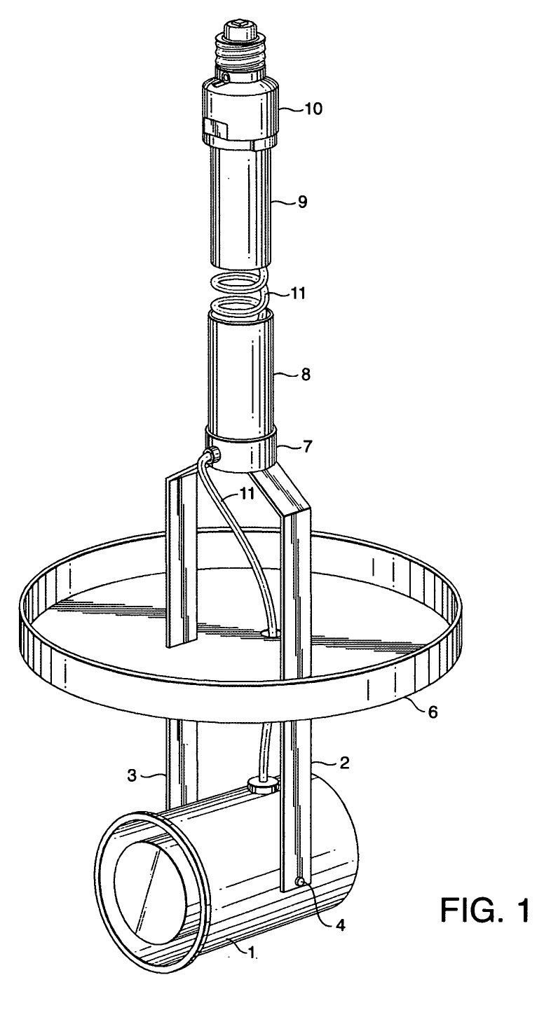

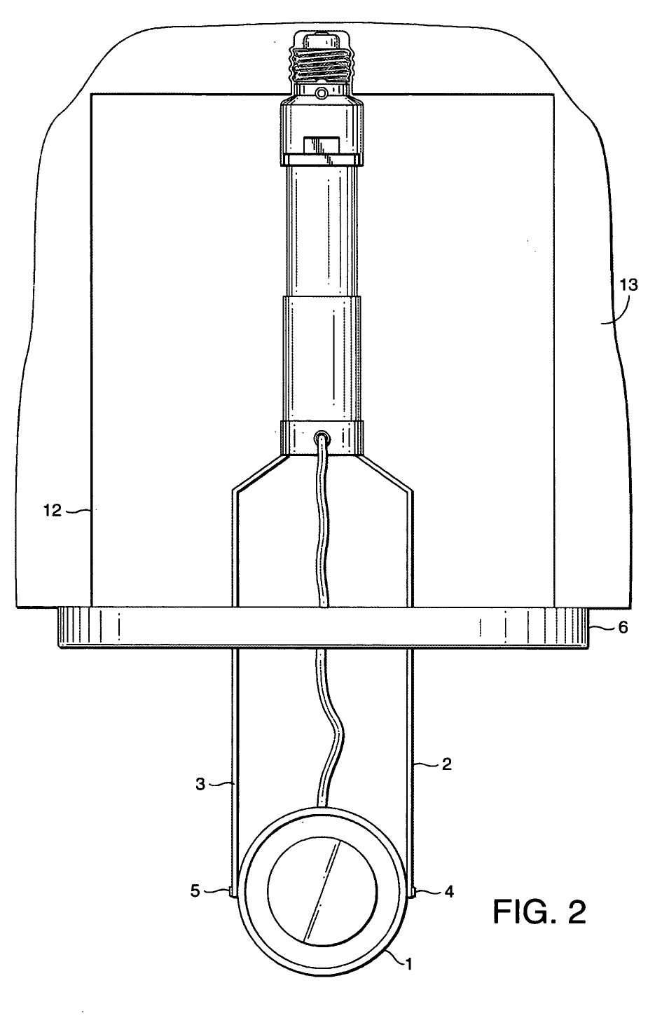

FIG. 1 is a perspective view of the spot light converter fixture of my invention. A spot light 1 is pivotally mounted on the arms 2 and 3 of a supporting frame. The pivots are shown at element 4 on arm 2 and element 5 (FIG. 2) on arm 3. The arms 2 and 3 also support a cover plate 6. The cover plate may be affixed to the arms 2 and 3 or may be slidably mounted on the arms. The arms 2 and 3 are connected to a rotatable swivel locking collar 7. The locking collar 7 is in turn connected to on portion 8 of an extension shaft assembly consisting of larger diameter shaft 8 and smaller diameter shaft 9. The two shafts are frictionally telescopically adjustable. Shaft 9 is connected to an Edison threaded electrical connector 10. An electrical wire 11 is shown connecting the spot light to the connector 10.

In operation, as shown in FIG. 1, the bulb of a recessed light fixture assembly 12 mounted within a ceiling or soffet 13 is removed and the apparatus of the FIG. 1 is inserted in the bulb socket. As desired, the position of the spotlight is adjusted in length, in angle and in pivot. The cover plate may also be positioned as desired to cover the opening of the recessed light. The locking collar may be locked if required to permit the device to be inserted into the recessed light fixture by rotation.

Further modifications to the apparatus of the invention may be made without departing from the spirit and scope of the invention; accordingly, what is sought to be protected is set forth in the appended claims.

What is claimed is:

1. A lighting fixture for converting a recessed light into a spot light comprising a spot light, an adjustable length supporting means for pivotally and rotatably mounting said spot light thereon, electrical connector means attached to said supporting means for providing electrical power to said spot light; and cover plate means attached to said supporting means for covering a portion of said recessed light.

2. The lighting fixture of claim 1 wherein said supporting means includes two arms for pivotally mounting said spot light there between.

3. The lighting fixture of claim 2 wherein said supporting means include an adjustable length shaft connected to said arms.

4. The lighting fixture of claim 3 further including a rotatable locking swivel mounted between said shaft and said arms.

5. The lighting fixture of claim 4 further wherein said cover plate is slidably mounted on said arms between said spot light and said rotatable locking swivel.

6. A recessed to spot light converter comprising a spot light, a supporting frame pivotally mounting said spot light, an adjustable length shaft attached to said supporting frame, rotatable swivel means attached to said shaft and to said frame to permit said frame to rotate about the axis of said shaft; a cover plate attached to said supporting frame between said rotatable locking swivel and said spot light, and Edison base electrical connector means attached to said shaft for attaching said converter to a recessed lighting fixture.
